(19) United States
(12) Patent Application Publication
(10) Pub. No.: US 2011/0199065 A1
(43) Pub. Date: Aug. 18, 2011

(54) DC-TO-DC CONVERTER

(75) Inventor: Tomohiro KUME, Osaka (JP)

(73) Assignee: PANASONIC CORPORATION, Osaka (JP)

(21) Appl. No.: 13/094,234

(22) Filed: Apr. 26, 2011

Related U.S. Application Data
(63) Continuation of application No. PCT/JP2010/006189, filed on Oct. 19, 2010.

(30) Foreign Application Priority Data
Oct. 19, 2009 (JP) 2009-240236

(51) Int. Cl. G05F 1/618

(52) U.S. Cl. 323/285

(57) ABSTRACT

A DC-to-DC converter includes a triangular wave generator, a variable gain amplifier configured to amplify an error between a reference voltage and a feedback voltage which is a feedback of an output voltage so that a gain relatively decreases as an input voltage increases, and relatively increases as the input voltage decreases, and a comparator configured to compare an output of the triangular wave generator with an output of the variable gain amplifier. The variable gain amplifier includes a differential pair configured to convert the feedback voltage and the reference voltage into currents, a Gilbert cell circuit configured to differentially receive the currents output from the differential pair, an output conversion circuit configured to convert differential outputs from the Gilbert cell circuit into a single output, and a tail current source configured to supply, to the differential pair, tail currents having a magnitude corresponding to the input voltage.

### CROSS-REFERENCE TO RELATED APPLICATIONS

This is a continuation of PCT International Application PCT/JP2010/006189 filed on Oct. 19, 2010, which claims priority to Japanese Patent Application No. 2009-240236 filed on Oct. 19, 2009. The disclosures of these applications including the specifications, the drawings, and the claims are hereby incorporated by reference in their entirety.

### BACKGROUND

The present disclosure relates to DC-to-DC converters, and more particularly, to the feedback control of DC-to-DC converters.

In general, DC-to-DC converters are used as power supply circuits for various electronic apparatuses. DC-to-DC converters change an input voltage by controlling switching of a switching device, to generate a desired output voltage.

The configuration of a conventional DC-to-DC converter is shown in FIG. 3. An error amplifier 109 amplifies an error between a voltage Vfb which is a feedback of an output voltage Vout, and a reference voltage Vr. The voltage Vfb is a voltage which is obtained by dividing the output voltage Vout using a resistor 107 and a resistor 108. A PWM comparator 111 compares an error signal Ve output from the error amplifier 109 with a triangular wave voltage Vosc output from a triangular wave generator 112. Thereafter, switching of a switching device 102 is controlled based on a PWM signal Vg output from the PWM comparator 111.

Here, the relationship between input and output voltages of the DC-to-DC converter is represented by:

Vₒᵤₜ₌D·Vin (1)

where Vin is the input voltage, Vout is the output voltage, and D is a duty ratio relating to a switching control.

The relationship between the alternating variation ̂d of the duty ratio D and the alternating variation ̂Vout of the output voltage Vout is represented by:

$$\frac{\hat{V} out}{\hat{d}} = \frac{Vin}{1 + s \cdot \frac{L}{Ro} + {s}^{2} LC} \qquad ( 2 )$$

where Ro is the resistance value of an external load (not shown), L is the inductance of an inductor 104, and Co is the capacitance of a capacitor 105.

Because the relationship between the error signal Ve and the duty ratio D is linear, the relationship between the alternating variation ̂Ve of the error signal Ve and the alternating variation ̂d of the duty ratio D is represented by:

$$\frac{\hat{d}}{\hat{V} e} = \frac{1}{Et} \qquad ( 3 )$$

where Et is the wave height of the triangular wave voltage Vosc.

According to expressions (1)-(3), the relationship between the alternating variation ̂Ve of the error signal Ve and the alternating variation ̂Vout of the output voltage Vout is represented by:

$$\frac{\hat{V} out}{\hat{V} e} = \frac{Vin / Et}{1 + s \cdot \frac{L}{Ro} + {s}^{2} LC} \qquad ( 4 )$$

In the conventional DC-to-DC converter, the wave height Et of the triangular wave voltage Vosc is changed in proportion to the input voltage Vin so that Vin/Et is kept constant, thereby stabilizing the output voltage Vout (see, for example, Japanese Patent Publication No.

### SUMMARY

In conventional DC-to-DC converters, when the input voltage range is expanded to both higher and lower voltages to cover, for example, 4 V to 20 V, the PWM comparator needs to be composed of components having a high breakdown voltage in order to withstand the maximum input voltage. However, components having a high breakdown voltage have a large size, and therefore, the circuit size of the DC-to-DC converter is likely to increase. Also, the cost of components having a high breakdown voltage is high, and therefore, the manufacturing cost of the DC-to-DC converter is likely to increase. On the other hand, the wave height of the triangular wave voltage is low in the vicinity of the minimum input voltage. Therefore, the switching control is likely to be disturbed even due to low noise in the input voltage, so that a stable output voltage may not be obtained.

The present disclosure describes implementations of a DC-to-DC converter which support a wide input voltage range.

In the DC-to-DC converter of FIG. 3, the relationship between the alternating variation ̂Ve of the error signal Ve and the alternating variation ̂Vout of the output voltage Vout is represented by:

$$\frac{\hat{V} e}{\hat{V} out} = \frac{AR 2}{R 1 + R 2} \qquad ( 5 )$$

where A is the gain of the error amplifier 109.

According to expressions (3)-(5), the following expression is obtained:

$$\{ \begin{matrix}\hat{V} out = G \cdot \hat{V} out \\ G = \frac{Vin / Et}{1 + s \cdot \frac{L}{Ro} + {s}^{2} LC} \cdot \frac{AR 2}{R 1 + R 2}\end{matrix} \qquad ( 6 )$$

It can be seen from expression (6) that an open loop gain G can be kept constant by causing Et and Vin×A to be constant.

Therefore, an example DC-to-DC converter of the present disclosure for changing an input voltage by controlling switching of a switching device to generate an output voltage, includes a triangular wave generator, a variable gain amplifier configured to amplify an error between a reference voltage and a voltage which is a feedback of the output voltage so that a gain relatively decreases as the input voltage increases, and relatively increases as the input voltage decreases, and a comparator configured to compare an output of the triangular wave generator with an output of the variable gain amplifier. The variable gain amplifier includes a differential pair configured to receive the voltage which is a feedback of the output voltage, and the reference voltage, and convert the voltages into currents, a Gilbert cell circuit configured to differentially receive the currents output from the differential pair, an output conversion circuit configured to convert differential outputs from the Gilbert cell circuit into a single output, and a tail current source configured to supply, to the differential pair, tail currents having a magnitude corresponding to the input voltage.

Therefore, the gain of the variable gain amplifier change in opposite directions with changes in the input voltage, and therefore, Vin×A in expression (6) is substantially constant, whereby the open loop gain G can be caused to be substantially constant. As a result, the output voltage can be stabilized while the wave height of the output of the triangular wave generator is kept constant. Also, because it is not necessary to expand the input range of the comparator, a component having a high breakdown voltage is no longer required.

### BRIEF DESCRIPTION OF THE DRAWINGS

FIG. 1 is a diagram showing a circuit configuration of a DC-to-DC converter according to an embodiment of the present disclosure.

FIG. 2 is a diagram showing an example circuit configuration of a variable gain amplifier.

FIG. 3 is a diagram showing a circuit configuration of a conventional DC-to-DC converter.

### DETAILED DESCRIPTION

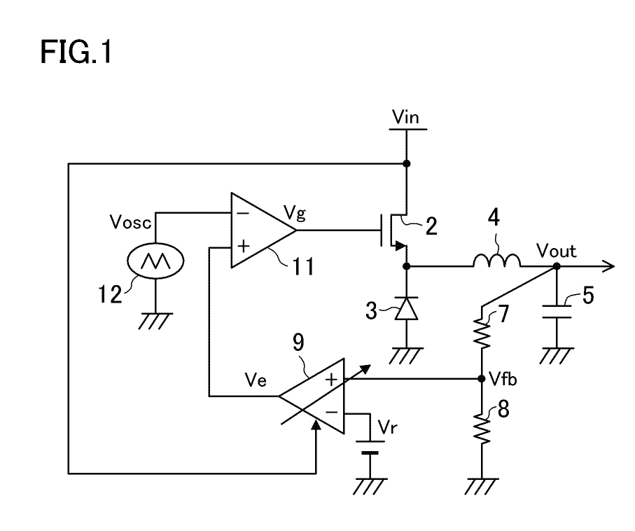

FIG. 1 is a diagram showing a circuit configuration of a DC-to-DC converter according to an embodiment of the present disclosure. The DC-to-DC converter controls switching of a switching device 2 to reduce an input voltage Vin from, for example, a buttery etc., thereby generating an output voltage Vout. An inductor 4 repeatedly stores and discharges energy via the switching device 2. A voltage generated in this case is rectified by a diode 3 and then smoothed by a capacitor 5, and is then output as the output voltage Vout.

A variable gain amplifier 9 amplifies an error between a voltage Vfb which is a feedback of the output voltage Vout, and a reference voltage Vr, with a gain which is inversely proportional to the input voltage Vin, to output an error signal Ve. As the variable gain amplifier 9, for example, an operational transconductance amplifier (OTA) may be used.

A comparator 11 compares a triangular wave voltage Vosc output from a triangular wave generator 12 with the error signal Ve, to output a pulse signal Vg. The pulse signal Vg is obtained by slicing the triangular wave voltage Vosc based on the error signal Ve. Switching of the switching device 2 is controlled based on the pulse signal Vg.

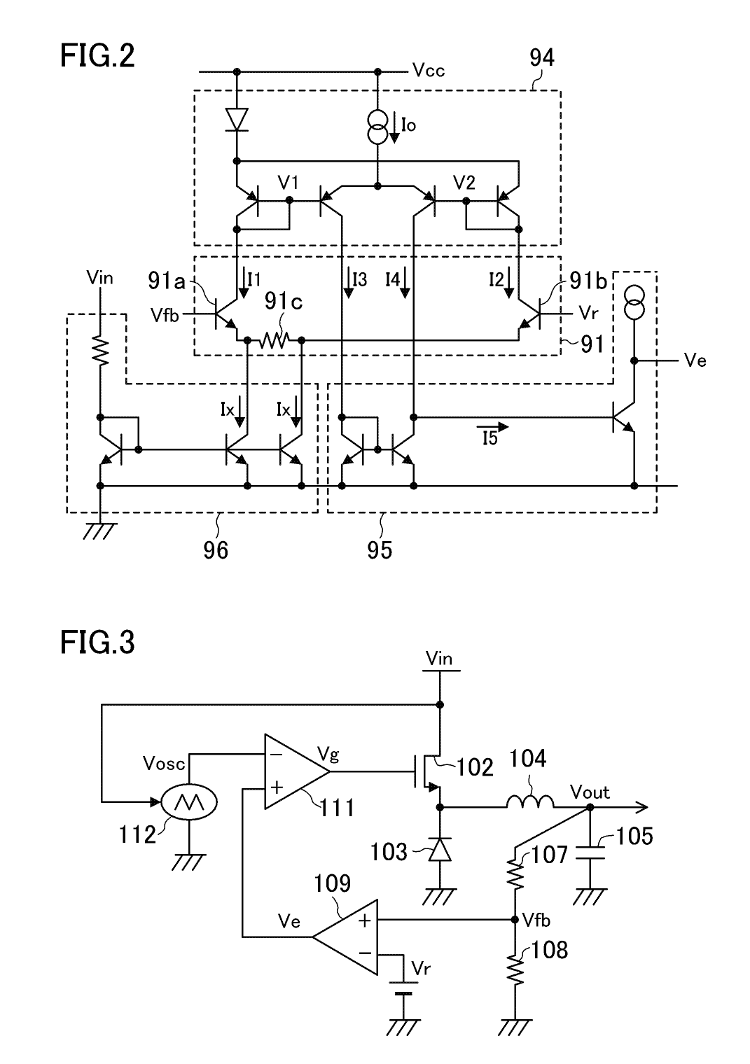

FIG. 2 shows an example circuit configuration of the variable gain amplifier 9. A differential pair 91 includes transistors 91a and 91b, and a resistor 91c provided between the emitters of the transistors 91a and 91b. The transistor 91a converts the voltage Vfb into a current I1. The transistor 91b converts the voltage Vr into a current I2. A Gilbert cell circuit 94 differentially amplifies the currents I1 and I2 to output currents I3 and I4, respectively.

An output conversion circuit 95 converts a difference current I5 between the currents I3 and I4 into the error signal Ve, and outputs the error signal Ve. A tail current source 96 supplies tail currents Ix to the emitters of the transistors 91a and 91b. The tail currents Ix are a mirror current of a current obtained by converting the input voltage Vin using a resistor.

The gain of the differential pair 91 is represented by:

$$\frac{\partial I 1}{\partial ( Vfb - Vr )} = - \frac{\partial I 2}{\partial ( Vfb - Vr )} = \frac{Ix}{Vt} + Re \qquad ( 7 )$$

where Vt is the thermal voltage of a transistor included in the variable gain amplifier 9, and Re is the resistance value of the resistor 91c.

The gain of an output stage of the Gilbert cell circuit 94 is represented by:

$$\frac{\partial I 3}{\partial ( V 1 - V 2 )} = - \frac{\partial I 4}{\partial ( V 1 - V 2 )} = \frac{Io}{2 Vt} \qquad ( 8 )$$

where Io is a current supplied to the output stage of the Gilbert cell circuit 94.

The gain of the transistors 91a and 91b is represented by:

$$\frac{\partial V 1}{\partial I 1} = \frac{\partial V 2}{\partial I 2} = - \frac{2 Vt}{Ix} \qquad ( 9 )$$

where V1 and V2 are the input voltages of the Gilbert cell circuit 94.

A transconductance from the input of the voltages Vfb and Vr to the output of the current I5 is obtained by multiplying expressions (7)-(9) together, and represented by:

$$\begin{matrix}\frac{\partial I 5}{\partial ( Vfb - Vr )} = \frac{\partial ( I 4 - I 3 )}{\partial ( Vfb - Vr )} \\ = - 2 \frac{Io}{2 Vt} \frac{2 Vt}{Ix} ( \frac{Ix}{Vt} + Re ) \\ = - 2 \frac{Io}{Ix} ( \frac{Ix}{Vt} + Re )\end{matrix} \qquad ( 10 )$$

Here, if it is assumed that Re>>Ix/Vt, the following expression is obtained:

$$\frac{\partial I 5}{\partial ( Vfb - Vr )} \approx - 2 \frac{Io}{Ix} Re \qquad ( 11 )$$

Thus, it can be seen that the transconductance represented by expression (11) is inversely proportional to the tail current Ix. Because the tail current Ix is proportional to the input voltage Vin, the transconductance of expression (11) is inversely proportional to the input voltage Vin. Here, because the gain of the variable gain amplifier 9 is proportional to the transconductance of expression (11), the gain of the variable gain amplifier 9 is inversely proportional to the tail current Ix.

Thus, according to this embodiment, the gain of the variable gain amplifier 9 is changed in inverse proportion to the input voltage Vin, and therefore, the output voltage Vout can be stabilized against the variation of the input voltage Vin. Also, the triangular wave voltage Vosc has a constant wave height, and therefore, it is not necessary to expand the input range of the comparator 11. Therefore, it is not necessary to use a component having a high breakdown voltage in the comparator 11.

Note that the gain of the variable gain amplifier 9 may not be accurately inversely proportional to the input voltage Vin. For example, the gain may be continuously varied with changes in the input voltage Vin so that the gain relatively decreases as the input voltage Vin increases, and relatively increases as the input voltage Vin decreases.

The DC-to-DC converter of this embodiment may be modified into one that performs a so-called average current mode control to control an average current flowing through the inductor 4. In this case, a current flowing through the inductor 4 may be detected. Also, the comparator 11 may compare a signal which is smoothed by adding, to the error signal Ve, an average value of voltage signals obtained by converting detected currents into voltages, with the triangular wave voltage Vosc.

While the step down DC-to-DC converter has been described above for the sake of convenience, the present disclosure is not limited to this. The present disclosure is also applicable to DC-to-DC converters of switching types, such as step up type, inverted type, etc.

While, in this embodiment, the so-called first Gilbert cell circuit has been employed for the variable gain amplifier 9, a second or third Gilbert cell circuit may be employed for the variable gain amplifier 9.

What is claimed is:

1. A DC-to-DC converter for changing an input voltage by controlling switching of a switching device to generate an output voltage, comprising:
a triangular wave generator;
a variable gain amplifier configured to amplify an error between a reference voltage and a voltage which is a feedback of the output voltage so that a gain relatively decreases as the input voltage increases, and relatively increases as the input voltage decreases; and
a comparator configured to compare an output of the triangular wave generator with an output of the variable gain amplifier,
wherein
the variable gain amplifier includes
a differential pair configured to receive the voltage which is a feedback of the output voltage, and the reference voltage, and convert the voltages into currents,
a Gilbert cell circuit configured to differentially receive the currents output from the differential pair,
an output conversion circuit configured to convert differential outputs from the Gilbert cell circuit into a single output, and
a tail current source configured to supply, to the differential pair, tail currents having a magnitude corresponding to the input voltage.

2. The DC-to-DC converter of claim 1, wherein
the differential pair includes
a first transistor configured to receive the voltage which is a feedback of the output voltage,
a second transistor configured to receive the reference voltage, and
a resistor coupled between emitters of the first and second transistors, and
the tail current source supplies tail currents having the same magnitude to the respective emitters of the first and second transistors.
